(19) United States
(12) Patent Application Publication
(10) Pub. No.: US 2005/0000132 A1
(43) Pub. Date: Jan. 6, 2005

(54) Roof rack reminder

(76) Inventors: Robert Frederick Hipple JR., Indianapolis, IN (US); Thomas Edward BonDurant, Indianapolis, IN (US)

Correspondence Address: JEFFREY R. LADE, ATTORNEY AT LAW, 13558 SILVERSTONE DRIVE, FISHERS, IN, 46038, US

(21) Appl. No.: 10/838,028

(22) Filed: May 3, 2004

Related U.S. Application Data
(60) Provisional application No. 60/468,000, filed on May 5, 2003.

(51) Int. Cl. G09F 7/22

(52) U.S. Cl. 40/617

(57) ABSTRACT

A reminder system for a vehicle with an equipment rack or other cargo attached to the roof of said vehicle comprising a sign attached to the inside of a garage door, such that when the garage door is opened, the sign hangs in the field of view of the driver, reminding the driver to check for clearance for such rack or cargo.

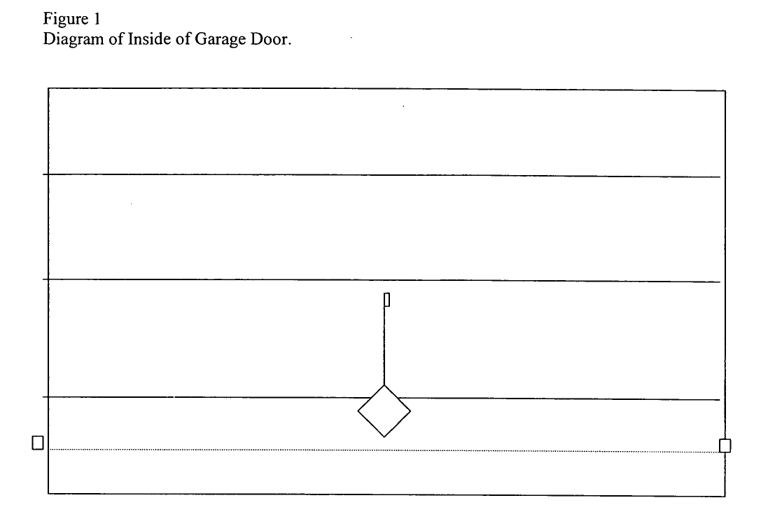

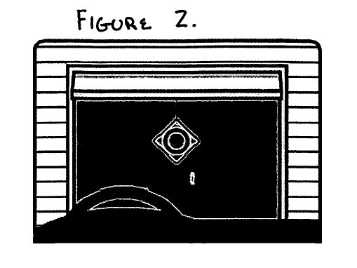

There has been no federally sponsored research or development of the invention.

### BACKGROUND OF THE INVENTION

Most people drive with a loaded vehicle on an infrequent basis. Therefore, they are accustomed to the standard height of their automobile. Placing outdoor recreation equipment (bicycles, kayaks, snow boards, etc.), luggage or other items on top of a vehicle obviously changes the minimum clearance in a garage. The change in clearance is easy to forget regardless of the experience of the driver. If the driver forgets about the change in clearance, the bicycle or other cargo, could strike the garage door or garage opening, causing severe damage to the equipment, roof rack, vehicle and the garage.

### DESCRIPTION

1. Field of the Invention

The present invention relates to vehicle roof racks, more particularly a reminder system for the driver of the vehicle to check for appropriate clearance for the equipment rack or other cargo before entering the garage.

2. Summary of the Invention

Accordingly, it is the object of the present invention to provide for a warning device to alert the driver upon opening the garage door. The preferred embodiment is a warning sign attached to a cord and an attachment device which is then used as follows:

The cord is placed through a hole in the top corner of the warning sign and a knot is tied in one end of the cord, to keep that sign from coming off the cord. The cord is attached to the inside of a garage door with an attachment device. The garage door safety sensor beam is located and the beam height at the center of the garage door is marked. The cord attachment device is attached 30″ to 40″ above the mark. The cord from the warning sign is attached to the attachment device and the cord length is adjusted so that bottom of warning sign is approximately 1″ above the garage door safety beam. The garage door should be opened and closed to insure proper functioning. A reminder decal is placed in the upper left corner of the windshield of the vehicle. The maximum total height of vehicle and cargo should be measured (plus a few inches for comfort). This is the minimum clearance measurement which should be noted on the reminder window decal.

1. A reminder system for a vehicle with an equipment rack or other cargo attached to the roof of said vehicle comprising: a sign attached to a cord, which cord is then attached to the inside of a garage door by an attachment device, such that when the garage door is opened, the sign hangs in the field of view of the driver, reminding the driver to check for clearance for such rack or cargo.
